(19) United States
(12) Patent Application Publication
(10) Pub. No.: US 2020/0121114 A1
(43) Pub. Date: Apr. 23, 2020

(54) PORTABLE CUP WITH FILTERING MECHANISM

(71) Applicant: Hongjiang Liu, Shenzhen (CN)

(72) Inventor: Hongjiang Liu, Shenzhen (CN)

(21) Appl. No.: 16/168,012

(22) Filed: Oct. 23, 2018

(51) Int. Cl. A47J 31/06; A47J 31/40; A47J 31/00; A47J 31/02

(52) U.S. Cl. CPC A47J 31/0642; A47J 31/02; A47J 31/005; A47J 31/407

(57) ABSTRACT

A portable filtering cup may include a main body, a lid on top of the main body and detachably connected to the main body, and a funnel in the main body. The top portion of the funnel has a protruding portion, and one side of the protruding portion has a water outlet portion. A rotating trough is formed on one side on top of the funnel and the other side thereof has an engaging trough. A capsule box is disposed on top of the funnel, and the capsule box has a rotating shaft and an engaging post, and a needle is disposed on top thereof.

### FIELD OF THE INVENTION

The present invention relates to a portable drinking cup with filtering mechanism, and more particularly to a portable drinking cup incorporated with a K-Cup capsule.

### BACKGROUND OF THE INVENTION

Conventional filtering cups or coffee makers usually have a funnel on the top and a container underneath. A piece of filter paper is disposed on top of the funnel, and hot water can be poured onto coffee powders on top of the filter paper. However, the funnel is too large to carry and cannot be used with K-Cup capsules, so it is not convenient for the users. Therefore, there remains a need for a new and improved filtering cup to overcome the problems stated above.

### SUMMARY OF THE INVENTION

In one aspect, a portable filtering cup may include a main body, a lid on top of the main body and detachably connected to the main body, and a funnel in the main body. The top portion of the funnel has a protruding portion, and one side of the protruding portion has a water outlet portion. A rotating trough is formed on one side on top of the funnel and the other side thereof has an engaging trough. A capsule box is disposed on top of the funnel, and the capsule box has a rotating shaft and an engaging post, and a needle is disposed on top thereof.

The portable filtering cup may further include a cup gasket between the lid and the main body, and the cup gasket is disposed in a trough of the lid. A ring gasket is disposed on an outer portion of the protruding portion. In one embodiment, the rotating trough of the funnel and the rotating shaft of the capsule box are movably connected with each other, and when the rotating shaft is engaged with the rotating trough, the capsule box can rotate for over ninety (90) degrees using the rotating shaft as a rotating axis. In another embodiment, the engaging trough is movably connected with the engaging post.

When in use, the lid is opened and the funnel and capsule box are taken out. The capsule box can be opened and rotated for 90 degrees, and a disposable K-Cup capsule can be disposed into the capsule box, rotated for 90 degrees, and securely disposed in the engaging trough with the engaging post. Meanwhile, the aluminum foil on top of the K-Cup capsule can be poked through by the needle and the protruding portion is inserted into the K-Cup capsule. The bottom portion of the K-Cup capsule is also poked through by the needle, and the funnel is disposed upside down into the main body. Hot water can then be poured into section A of the funnel, and flows to the K-Cup capsule through the water outlet portion on one side of the protruding portion. The hot water can mix with the coffee powders in the K-Cup capsule and through the filter paper therein, the coffee can be brewed and flew into section B of the main body.

### BRIEF DESCRIPTION OF THE DRAWINGS

FIG. 1 illustrates a schematic view of the portable filtering cup in the present invention.

FIG. 2 illustrates a schematic view of the portable filtering cup in the present invention when in use.

FIG. 3 is an exploded view of the portable filtering cup in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

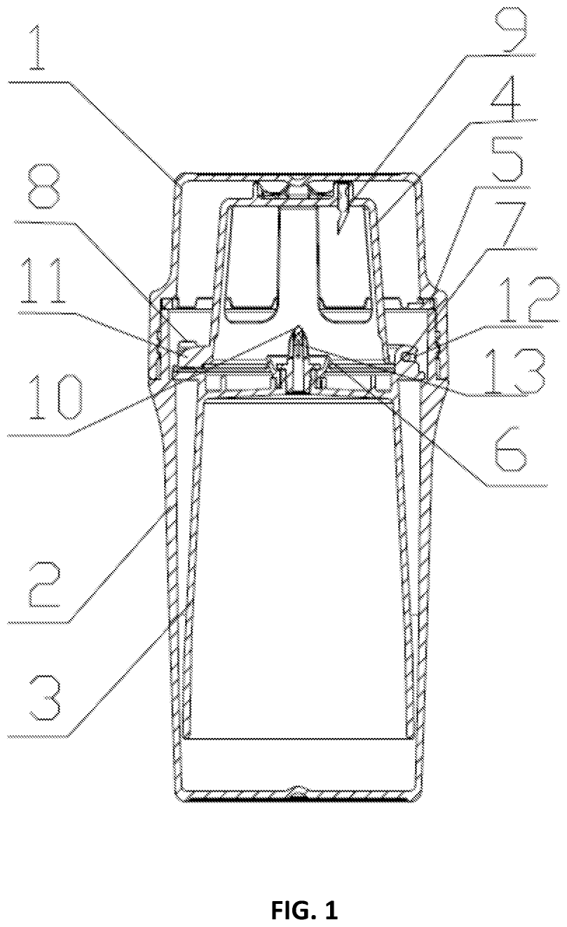

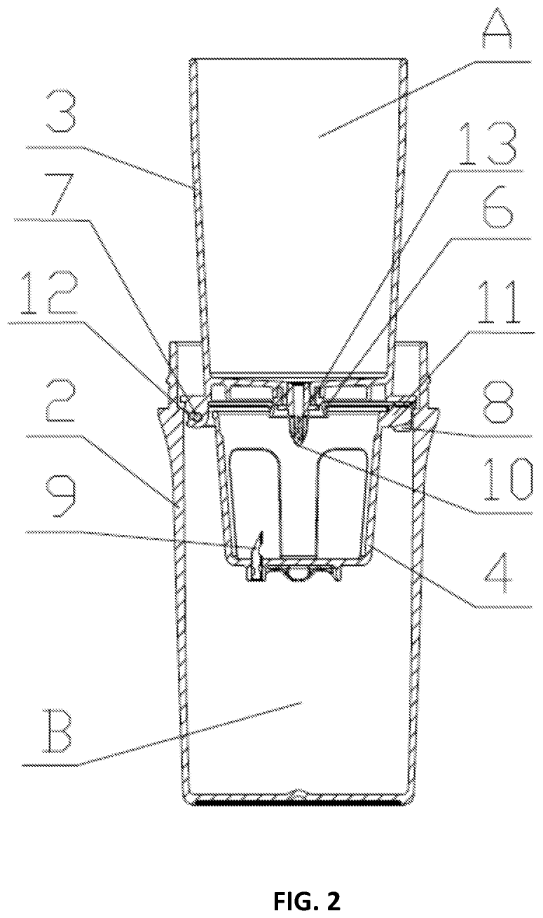

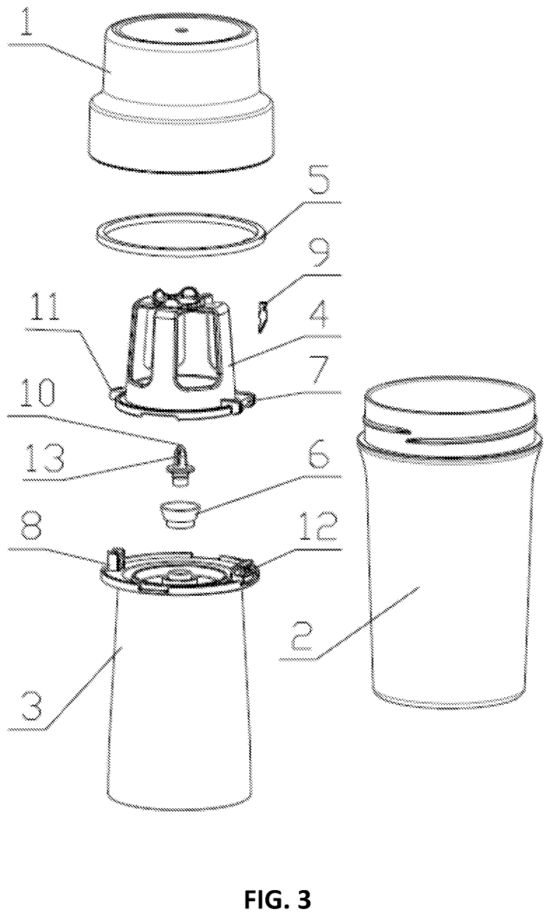

In one aspect, referring to FIGS. 1 to 3, a portable filtering cup may include a main body 2, a lid 1 on top of the main body 2 and detachably connected to the main body 2, and a funnel 3 in the main body 2. The top portion of the funnel 3 has a protruding portion 10, and one side of the protruding portion 10 has a water outlet portion 13. A rotating trough 12 is formed on one side on top of the funnel 3 and the other side thereof has an engaging trough 8. A capsule box 4 is disposed on top of the funnel 3, and the capsule box 4 has a rotating shaft 7 and an engaging post 11, and a needle 9 is disposed on top thereof.

The portable filtering cup may further include a cup gasket 5 between the lid 1 and the main body 2, and the cup gasket 5 is disposed in a trough of the lid 1. A ring gasket 6 is disposed on an outer portion of the protruding portion 10. In one embodiment, the rotating trough 12 of the funnel 3 and the rotating shaft 7 of the capsule box 4 are movably connected with each other, and when the rotating shaft 7 is engaged with the rotating trough 12, the capsule box 4 can rotate for over ninety (90) degrees using the rotating shaft 7 as a rotating axis. In another embodiment, the engaging trough 8 is movably connected with the engaging post 11.

When in use, the lid is opened and the funnel 3 and capsule box 4 are taken out. The capsule box 4 can be opened and rotated for 90 degrees, and a disposable K-Cup capsule can be disposed into the capsule box 4, rotated for 90 degrees, and securely disposed in the engaging trough 8 with the engaging post 11. Meanwhile, the aluminum foil on top of the K-Cup capsule can be poked through by the needle 9 and the protruding portion 10 is inserted into the K-Cup capsule. The bottom portion of the K-Cup capsule is also poked through by the needle 9, and the funnel 3 is disposed upside down into the main body 2. Hot water can then be poured into section A of the funnel 3, and flows to the K-Cup capsule through the water outlet portion 13 on one side of the protruding portion 10. The hot water can mix with the coffee powders in the K-Cup capsule and through the filter paper therein, the coffee can be brewed and flew into section B of the main body 2.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A portable filtering cup comprising a main body, a lid on top of the main body and detachably connected thereto, and a funnel in the main body, wherein a top portion of the funnel has a protruding portion, and one side of the protruding portion has a water outlet portion; a rotating trough is formed on one side on top of the funnel and the other side thereof has an engaging trough; a capsule box is disposed on top of the funnel, and the capsule box has a rotating shaft and an engaging post; and a needle is disposed on top thereof.

2. The portable filtering cup of claim 1, further comprising a cup gasket between the lid and the main body, and the cup gasket is disposed in a trough of the lid.

3. The portable filtering cup of claim 1, wherein a ring gasket is disposed on an outer portion of the protruding portion

4. The portable filtering cup of claim 1, wherein the rotating trough of the funnel and the rotating shaft of the capsule box are movably connected with each other, and when the rotating shaft is engaged with the rotating trough, the capsule box can rotate for over ninety (90) degrees via the rotating shaft.

5. The portable filtering cup of claim 1, wherein the engaging trough is movably connected with the engaging post.
